(19) United States
(12) Patent Application Publication
(10) Pub. No.: US 2026/0353514 A1
(43) Pub. Date: Nov. 5, 2026

(54) FILM-TYPE RADIATION HEATER

(71) Applicants: LS CABLE & SYSTEM LTD., Anyang-si, Gyeonggi-do (KR); NURI VISTA CO. LTD., Seocho-gu, Seoul (KR)

(72) Inventors: Sung Hoon MOON, Bucheon-si, Gyeonggi-do (KR); Seong Sil PARK, Namdong-gu, Incheon (KR); Yong Hwan GU, Yeonsu-gu, Incheon (KR); Myeong Jong GO, Namdong-gu, Incheon (KR)

(21) Appl. No.: 19/105,097

(22) PCT Filed: Aug. 18, 2023
(86) PCT No.: PCT/KR2023/012236

§ 371 Date: Feb. 20, 2025

(30) Foreign Application Priority Data
Sep. 2, 2022 (KR) 10-2022-0111089

(51) Int. Cl. H05B 3/03; H05B 3/12; H05B 3/20

(52) U.S. Cl. CPC H05B 3/03; H05B 3/12; H05B 3/20; H05B 2203/002; H05B 2203/013; H05B 2203/032

(57) ABSTRACT

The present disclosure relates to a film-type radiation heater. Specifically, the present disclosure relates a film-type radiation heater which comprises a printed electrode, and thus not only can reduce the manufacturing cost, but can also ensure a sufficient heating area, increase the allowed current range of the electrode, and reduce the hot-spot effect, thereby implementing high-efficiency heating.

### CROSS-REFERENCE TO RELATED APPLICATIONS

The present application is a National Stage of International Application No. PCT/KR2023/012236, filed on Aug. 18, 2023, which claims priority to Korean Application No. 10-2022-0111089, filed Sep. 2, 2022, the entire contents of each hereby incorporated by reference.

### FIELD

The present disclosure relates to a film-type radiation heater. Specifically, the present disclosure relates to a film-type radiation heater that is capable of achieving high-efficiency heating by reducing manufacturing costs due to the inclusion of a printed electrode, securing a sufficient heating area, increasing the allowed current range of the electrode, and reducing the hot-spot effect.

### BACKGROUND

A radiation heater refers to a heating device that uses radiant heat from a heat source and can be used in various fields such as construction, agriculture, healthcare, beauty, and automotive industries. In particular, the film-type radiation heater, which excels in flexibility and bendability and can be applied to surfaces of various shapes, can be applied to areas closest to the driver or passengers, such as the front of the knees of the driver or passengers, to enhance driving convenience for automobile drivers during winter.

FIG. 1 schematically illustrates the cross-sectional structure of a conventional film-type radiation heater, and FIG. 2 illustrates a cross-sectional view taken along line A-A′ in FIG. 1.

As illustrated in FIGS. 1 and 2, the conventional film-type radiation heater may include an electrode wiring pattern 20 including a pair of electrodes with different polarities on the upper surface of a base substrate 10, one or more heating elements 30 connected to the electrode wiring pattern 20, a cover 40 to protect the electrode wiring pattern 20 and the heating element 30 from the outside.

In such a conventional film-type radiation heater, the electrode wiring pattern 20 is formed by etching copper foil (Cu foil) or similar materials that are laminated on the film. Since the cost of the film with the laminated copper foil is high, a method of forming an electrode wiring pattern 20 by printing a metal paste on the base substrate 10 using a printing technique such as screen printing, gravure printing, roll-to-roll gravure printing, comma coating, roll-to-roll comma coating, flexo, imprinting, or offset printing, and then drying and curing the metal paste at 100 to 180 °C is being explored.

FIG. 3 illustrates a cross-sectional view of one embodiment in which a printed electrode is formed in a conventional film-type radiation heater, and FIG. 4 illustrates a cross-sectional view of another embodiment in which a printed electrode is formed in a conventional film-type radiation heater.

Specifically, as illustrated in FIG. 3, one or more heating elements 30 are first printed and formed on the upper surface of the base film 10, and then electrodes with different polarities are printed at both ends of each heating element 30 to form the electrode wiring pattern 20. Alternatively, as illustrated in FIG. 4, the electrode wiring pattern 20 is formed by printing electrodes on the upper surface of the base film 10, and then one or more heating elements 30 are printed such that their both ends are connected to electrodes with different polarities.

However, the printed electrode has the issue of a lower allowed current and the potential for hot-spot effect compared to conventional etched-type electrodes. To increase the allowed current and reduce the hot-spot effect, it is necessary to increase the width or height of the electrode. However, in such cases, the area of the heating element decreases, which in turn reduces the heating area, resulting in the problem that sufficient heat generation cannot be achieved.

Therefore, there is an urgent need for a film-type radiation heater that includes a printed electrode, which can reduce manufacturing costs, secure a sufficient heating area, increase the allowed current range of the electrode, and reduce the hot-spot effect, thereby achieving high-efficiency heating.

### SUMMARY

The present disclosure is directed to providing a film-type radiation heater that reduces manufacturing costs by including a printed electrode.

In addition, the present disclosure aims to provide a film-type radiation heater that can achieve high-efficiency heating by securing a sufficient heating area, increasing the allowed current range of an electrode, and reducing the hot-spot effect.

To achieve the objects, the present disclosure is directed to providing
a film-type radiation heater. The film-type radiation heater may include: a base substrate; an electrode wiring pattern formed on one surface of the base substrate and including a pair of electrodes with different polarities; and one or more heating elements, each having both ends connected to each of the pair of electrodes, in which the electrode may include a primary electrode having a side surface that is spaced apart from or in contact with the heating element without overlapping the heating element, and a secondary electrode being in contact with both the primary electrode and the heating element.

Here, the secondary electrode may be formed on top of the primary electrode and overlap the heating element to form an overlapping region.

In addition, a width of the secondary electrode may be defined by Equation 1 below.

Secondary electrode width=Primary electrode width+(Distance between primary electrode and heating element×2)+(Overlap distance between heating element and secondary electrode×2) [Equation 1]

Further, a width of the primary electrode may be at least 45% of the width of the secondary electrode, a distance between the primary electrode and the heating element may be at least 0.1 mm, and an overlap distance between the heating element and the secondary electrode may be at least 0.5 mm.

Meanwhile there is provided a film-type radiation heater. The film-type radiation heater may include: a base substrate; an electrode wiring pattern formed by printing metal paste on one surface of the base substrate, including a pair of electrodes with different polarities; and one or more heating elements, each having both ends connected to each of the pair of electrodes, in which the electrodes may include: a primary electrode having at least one end connected to the heating element such that the heating element overlaps at least one end, and formed by printing metal paste; and a secondary electrode formed by printing metal paste on an upper surface of the primary electrode and having a side surface that is spaced apart from or in contact with the heating element without overlapping the heating element.

Here, the secondary electrode may be formed on top of the primary electrode.

In addition, a width of the primary electrode may be defined by Equation 2 below.

Primary electrode width=Secondary electrode width+(Distance between secondary electrode and heating element×2)+(Overlap distance between heating element and primary electrode×2) [Equation 2]

Further, a width of the secondary electrode may be at least 45% of the width of the primary electrode, a distance between the secondary electrode and the heating element may be at least 0.1 mm, and an overlap distance between the heating element and the primary electrode may be at least 0.5 mm.

Meanwhile, a total height of the electrode, including a height of the primary electrode and a height of the secondary electrode, may be 25 μm or less.

In addition, the heating element may be formed by printing metal paste.

Here, the metal paste may include a base resin, metal powder, and a solvent.

In addition, the base resin may include one or more selected from the group consisting of epoxy resin, polyester resin, and urethane resin.

Further, the metal powder may include a powder made of one or more metal materials selected from the group consisting of silver (Ag), copper (Cu), aluminum (Al), stainless steel (SUS), nickel (Ni), and alloys thereof.

In addition, the solvent may include one or more selected from the group consisting of carbitol acetate, ethyl carbitol, butyl carbitol acetate, and butyl carbitol.

Further, based on a total weight of the metal paste, the content of the base resin may be 1 to 10 wt %, the content of the metal powder may be 75 to 90 wt %, and the content of the solvent may be 8.9 to 13 wt %.

Meanwhile, the heating element may be formed by printing heating paste.

Here, the heating paste may include a base resin and conductive particles.

The film-type radiation heater according to the present disclosure exhibits the excellent effect of reducing manufacturing costs by including a printed electrode.

In addition, the film-type radiation heater according to the present disclosure exhibits the excellent effect of achieving high-efficiency heating by securing a sufficient heating area through a new electrode structure, increasing the allowed current range of the electrode, and reducing the hot-spot effect.

### BRIEF DESCRIPTION OF THE DRAWINGS

FIG. 1 schematically illustrates a perspective view of a conventional film-type radiation heater.

FIG. 2 illustrates a cross-sectional view taken along line A-A′ in FIG. 1.

FIG. 3 illustrates a cross-sectional view of one embodiment in which a printed electrode is formed in a conventional film-type radiation heater.

FIG. 4 illustrates a cross-sectional view of another embodiment in which a printed electrode is formed in a conventional film-type radiation heater.

FIG. 5 is a top plan view of the film-type radiation heater according to the present disclosure.

FIG. 6 is a cross-sectional view taken along line A-A′ in FIG. 5.

FIG. 7 is a cross-sectional view of another embodiment of the film-type radiation heater according to the present disclosure.

FIG. 8 is a graph showing the voltage versus conducting current and output for the film-type radiation heaters in the embodiment and comparative example, respectively.

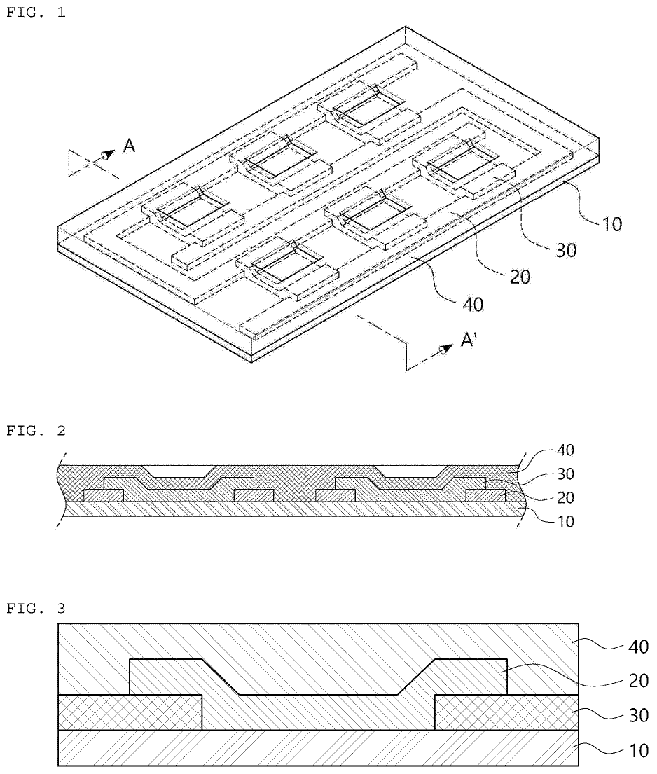

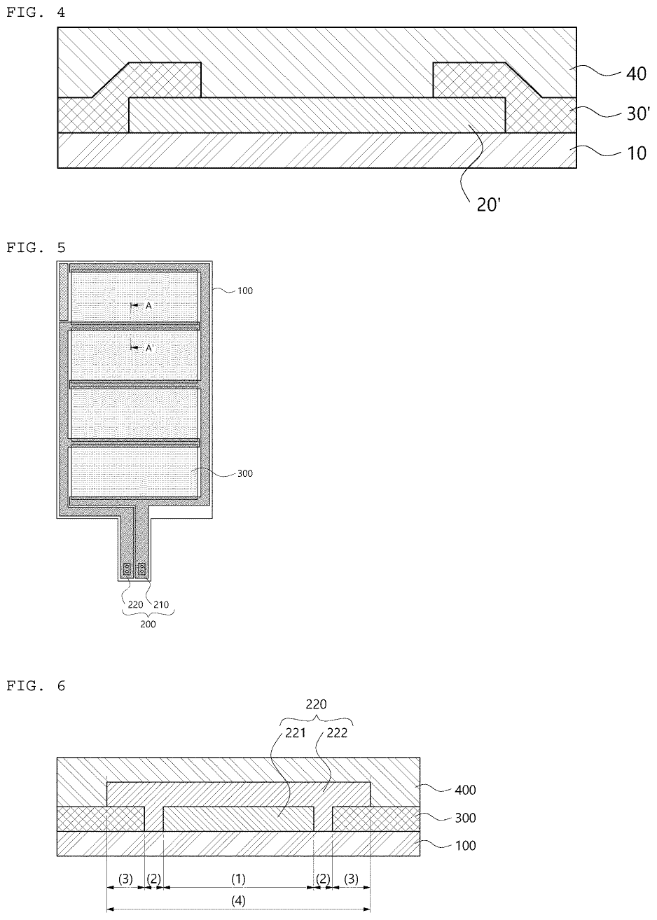

### DETAILED DESCRIPTION

Hereinafter, exemplary embodiments of the present disclosure will be described in detail with reference to the accompanying drawings. However, the present disclosure is not limited to the exemplary embodiments to be described below and may be specified as other aspects. On the contrary, the embodiments introduced herein are provided to make the disclosed content thorough and complete, and sufficiently transfer the spirit of the present disclosure to those skilled in the art. Like reference numerals indicate like constituent elements throughout the specification.

FIG. 5 is a top plan view of a film-type radiation heater according to the present disclosure, and FIG. 6 is a cross-sectional view taken along line A-A′ in FIG. 5.

As illustrated in FIG. 5, the film-type radiation heater according to the present disclosure may include a base substrate 100, an electrode wiring pattern 200 formed by printing metal paste on one surface of the base substrate 100 and including a pair of electrodes 210 and 220 with different polarities, one or more heating elements 300 each having both ends connected to the electrodes 210 and 220, and an insulating layer 400 that protects the electrode wiring pattern 200 and the one or more heating elements 300 from the outside.

In particular, as illustrated in FIG. 6, the electrode 220 forming the electrode wiring pattern 200 may include a primary electrode 221, which does not overlap the heating element 300 and has a side surface that is spaced apart from or in contact with the heating element 300, and a secondary electrode 222, which is in contact with both the primary electrode 221 and the heating element 300. The electrode 210 with the opposite polarity may also be configured in the same way as electrode 220, with a primary electrode and a secondary electrode.

Through this primary and secondary electrode stacking structure, the film-type radiation heater according to the present disclosure can secure a sufficient heating area, increase the allowed current range of the electrode, and reduce the hot-spot effect, thereby achieving high-efficiency heating.

Specifically, the width of the secondary electrode may be defined by Equation 1 below with reference to FIG. 6.

Secondary electrode width=Primary electrode width+(Distance between primary electrode and heating element×2)+(Overlap distance between heating element and secondary electrode×2) [Equation 1]

Specifically, the total height of the primary electrode and secondary electrode may be 25 μm or less, for example, 10 to 25 μm. The width (1) of the primary electrode may be at least 45% of the width (4) of the secondary electrode. The distance (2) between the primary electrode and the heating element may be 0.1 mm or more, for example, 0.1 to 0.5 mm. The overlap distance (3) between the heating element and the secondary electrode may be 0.5 mm or more, for example, 0.5 to 1.0 mm.

When the width of the secondary electrode is below a standard, the allowed current range of the electrode may fall short of the standard, potentially causing a hot-spot effect. On the other hand, when it exceeds the standard, the heating area may be unnecessarily reduced, resulting in insufficient heating performance.

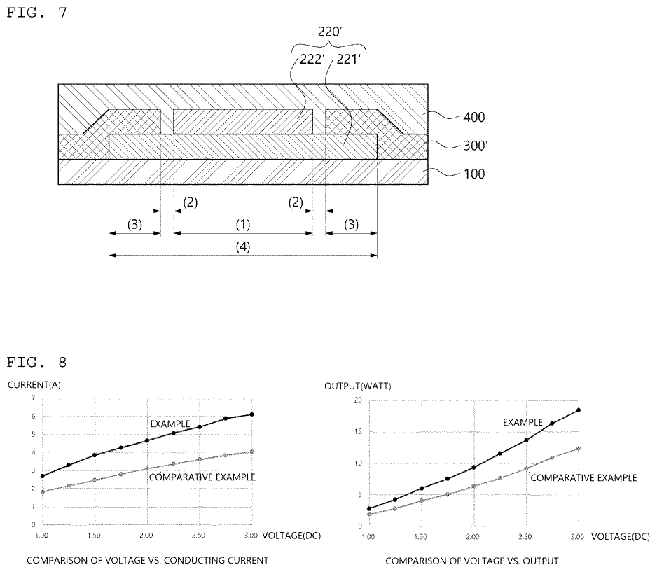

FIG. 7 is a cross-sectional view of another embodiment of the film-type radiation heater according to the present disclosure.

As illustrated in FIG. 7, the film-type radiation heater according to the present disclosure may include a pair of electrodes with different polarities and one or more heating elements 300′ whose both ends are connected to each of the pair of electrodes. One electrode 220′ of the pair of electrodes may include a primary electrode 221′ having at least one end connected to the heating element 300′ such that the heating element 300′ overlaps at least one end, and formed by printing of metal paste, and a second electrode 222′ formed on the upper surface of the primary electrode 221′ by printing of metal paste and having a side surface spaced apart from or in contact with the heating element 300′ without overlapping the heating element 300′.

Here, the width of the primary electrode may be defined by Equation 2 below with reference to FIG. 7.

Primary electrode width=Secondary electrode width+(Distance between secondary electrode and heating element×2)+(Overlap distance between heating element and primary electrode×2) [Equation 2]

Specifically, the total height of the primary electrode and secondary electrode may be 25 μm or less, for example, 10 to 25 μm. The width (1) of the secondary electrode may be at least 45% of the width (4) of the primary electrode. The distance (2) between the secondary electrode and the heating element may be 0.1 mm or more, for example, 0.1 to 0.5 mm. The overlap distance (3) between the heating element and the primary electrode may be 0.5 mm or more, for example, 0.5 to 1.0 mm.

When the width of the primary electrode is below a standard, the allowed current range of the electrode may fall short of the standard, potentially causing a hot-spot effect. On the other hand, when it exceeds the standard, the heating area may be unnecessarily reduced, resulting in insufficient heating performance.

Meanwhile, the base substrate 100 and the insulating layer 400 may include one or more plastic materials selected from the group consisting of polyimide (PI), polyethylene terephthalate (PET), polyacrylonitrile (PAN), polyurethane (PU), silicone, polycarbonate (PC), teflon, liquid crystal polymer (LCP), poly ether ether ketone (PEEK), polyethersulphone (PES), polyacrylate (PAR), polyetherimide (PEI), polyethylene naphthalate (PEN), polyphenylene sulfide (PPS), polyallylate, cellulose triacetate (CTA), cellulose acetate propionate (CAP), and the like, depending on the application and operating temperature of the film-type radiation heater, and preferably, may include a plastic film consists of polyimide (PI).

The metal paste used to form the electrode may be manufactured by mixing metal powder with a base resin. Here, the base resin may include one or more selected from epoxy resin, polyester resin, urethane resin, and the like, and the metal powder may include a powder made of metal materials such as silver (Ag), copper (Cu), aluminum (Al), stainless steel (SUS), nickel (Ni), or alloys thereof.

In addition, the metal paste may further include one or more solvents selected from carbitol acetate, ethyl carbitol, butyl carbitol acetate, butyl carbitol, and the like for viscosity adjustment to improve coating workability, as well as other additives such as wetting dispersants.

Here, based on the total weight of the metal paste, the content of the base resin may be 1 to 10 wt %, the content of the metal powder may be 75 to 90 wt %, the content of the solvent may be 8.9 to 13 wt %, and the content of other additives may be 0.1 to 2 wt %.

The metal paste may be manufactured by first mixing the base resin, solvent, other additives, and then blending the metal powder, removing bubbles while stirring, and milling using a 3-roll mill or the like.

The heating element 300 or 300′ may generate heat up to 200 °C or higher, preferably up to 300 °C or higher. Each heating element is formed by printing a heating paste containing a base resin and conductive particles on one surface of the base substrate 100, through the electrode wiring pattern 200, and then drying the paste, allowing the heating elements to be connected in series or parallel to each other.

The base resin may include epoxy resin, acrylic resin, and the like, and the conductive particles may include carbon-based particles such as carbon black, carbon nanotubes, graphite, and activated carbon, and may additionally include metal powders such as silver (Ag), copper (Cu), and nickel (Ni). In particular, since carbon nanotubes have a high aspect ratio, they may form a sufficient electrical network with a small amount, as well as enhance the glass transition temperature and heat resistance of the heating element composition.

### EXAMPLES

### 1. Manufacturing Example

Two samples of the comparative example of a film-type radiation heater with the cross-sectional structure of FIG. 3 and two samples of the example of a film-type radiation heater with the cross-sectional structure of FIG. 6 were each manufactured. Each sample has a total electrode length of 100 mm and a top plan view as illustrated in FIG. 5.

### 2. Resistance Evaluation

The power was applied to each sample of the example and comparative example, and the resistance of the film-type radiation heater product and the electrode resistance were each measured 10 times. The measurement results are shown in Table 1 below.

TABLE 1

| | Product resistance | | | | Electrode resistance | | | |
|---|---|---|---|---|---|---|---|---|
| | (Ω · mm) | | | | (Ω · mm) | | | |
| | Comparative | | | | Comparative | | | |
| | example | | Example | | example | | Example | |
| | Sam- | Sam- | Sam- | Sam- | Sam- | Sam- | Sam- | Sam- |
| | ple 1 | ple 2 | ple 1 | ple 2 | ple 1 | ple 2 | ple 1 | ple 2 |
| 1 times | 6.33 | 5.74 | 5.56 | 5.71 | 0.224 | 0.208 | 0.130 | 0.129 |
| 2 times | 6.00 | 6.00 | 6.49 | 5.19 | 0.244 | 0.228 | 0.142 | 0.139 |
| 3 times | 5.69 | 5.85 | 5.91 | 5.08 | 0.244 | 0.230 | 0.141 | 0.139 |
| 4 times | 6.30 | 5.97 | 5.78 | 5.50 | 0.221 | 0.207 | 0.129 | 0.130 |
| 5 times | 5.97 | 5.81 | 6.51 | 5.63 | 0.243 | 0.233 | 0.142 | 0.142 |
| 6 times | 5.67 | 5.84 | 5.49 | 5.57 | 0.226 | 0.202 | 0.132 | 0.132 |
| 7 times | 5.69 | 5.98 | 5.54 | 5.29 | 0.261 | 0.231 | 0.138 | 0.145 |
| 8 times | 5.97 | 6.07 | 5.40 | 5.45 | 0.255 | 0.228 | 0.137 | 0.143 |
| 9 times | 6.18 | 5.73 | 5.08 | 5.24 | 0.226 | 0.214 | 0.131 | 0.135 |
| 10 times | 5.89 | 5.57 | 5.10 | 5.44 | 0.249 | 0.237 | 0.147 | 0.148 |
| Minimum | 5.67 | 5.57 | 5.08 | 5.08 | 0.221 | 0.202 | 0.129 | 0.129 |
| Maximum | 6.33 | 6.07 | 6.51 | 5.71 | 0.261 | 0.237 | 0.147 | 0.148 |
| Average | 5.97 | 5.85 | 5.70 | 5.41 | 0.240 | 0.221 | 0.137 | 0.138 |
| Total | 5.91 | | 5.56 | | 0.231 | | 0.138 | |
| average | | | | | | | | |

As shown in Table 1, the film-type radiation heater of the example according to the present disclosure exhibits a decrease of approximately 40% in electrode resistance and a decrease of approximately 6% in product resistance compared to the conventional comparative example. This confirms that the allowed current of the electrode is increased, and as a result, the hot-spot effect can be reduced.

### 3. Heating Evaluation

The respective film-type radiation heater of the example and comparative example were subjected to a DC 25 V power supply, and the temperature at heating element 1, located at the lowest part in the top plan view, heating element 2, located at the highest part, electrode 1 with negative polarity, and electrode 2 with positive polarity were measured by capturing the thermal image with a thermal camera while in a heated state. The measurement results are shown in Table 2 below.

TABLE 2

| | Comparative example (°C) | | | | Example (°C) | | | |
|---|---|---|---|---|---|---|---|---|
| | | | | Difference | | | | Difference |
| | Minimum | Maximum | Difference | Average | Minimum | Maximum | Difference | Average |
| Electrode 1 | 32.7 | 43.5 | 10.8 | 11.9 | 33.9 | 40.3 | 6.4 | 5.5 |
| Electrode 2 | 30.8 | 43.8 | 13.0 | | 30.0 | 34.6 | 4.6 | |
| Heating | 128.8 | 175.1 | 46.3 | 38.5 | 130.6 | 165.1 | 34.5 | 27.3 |
| element 1 | | | | | | | | |
| Heating | 134.6 | 165.3 | 30.7 | | 147.1 | 167.2 | 20.1 | |
| element 2 | | | | | | | | |

As shown in Table 2, the film-type radiation heater of the example exhibited approximately a 54% reduction in the heating deviation at the pair of electrodes and approximately a 29% reduction in the heating deviation of the heating element compared to the film-type radiation heater of the comparative example. This confirms that the improvement in the electrode structure has led to a reduction in the heating deviation at the pair of electrodes and one or more heating elements.

### 4. Evaluation of Electrical Characteristics of Film-Type Radiation Heater

The conducting current and output according to the applied voltage were measured for each film-type radiation heater of the example and the comparative example, and the measurement results are shown in the graph of FIG. 8. Here, the total width of one electrode in each film-type radiation heater of the example and the comparative example is 7 mm, and the total length is 180 mm.

As illustrated in FIG. 8, the film-type radiation heater of the example exhibited higher conducting current and output in relation to the applied voltage compared to the film-type radiation heater of the comparative example. This confirms that the electrode resistance has been improved, and consequently, the conversion efficiency of electrical energy through the low-resistance electrode has been enhanced.

While the present disclosure has been described above with reference to the exemplary embodiments, it may be understood by those skilled in the art that the present disclosure may be variously modified and changed without departing from the spirit and scope of the present disclosure disclosed in the claims. Therefore, it should be understood that any modified embodiment that essentially includes the constituent elements of the claims of the present disclosure is included in the technical scope of the present disclosure.

1. A film-type radiation heater, comprising:
a base substrate;
an electrode wiring pattern formed on one surface of the base substrate and including a pair of electrodes with different polarities; and
one or more heating elements, each having both ends connected to each of the pair of electrodes,
wherein the electrode include:
a primary electrode having a side surface that is spaced apart from or in contact with the heating element without overlapping the heating element; and
a secondary electrode being in contact with both the primary electrode and the heating element.

2. The film-type radiation heater of claim 1, wherein the secondary electrode is formed on top of the primary electrode and overlaps the heating element to form an overlapping region.

3. The film-type radiation heater of claim 2, wherein a width of the secondary electrode is defined by Equation 1 below.
Secondary electrode width=Primary electrode width+(Distance between primary electrode and heating element×2)+(Overlap distance between heating element and secondary electrode×2) [Equation 1]

4. The film-type radiation heater of claim 3, wherein a width of the primary electrode is at least 45% of the width of the secondary electrode, a distance between the primary electrode and the heating element is at least 0.1 mm, and an overlap distance between the heating element and the secondary electrode is at least 0.5 mm.

5. A film-type radiation heater, comprising:
a base substrate;
an electrode wiring pattern formed by printing metal paste on one surface of the base substrate, including a pair of electrodes with different polarities; and
one or more heating elements, each having both ends connected to each of the pair of electrodes,
wherein the electrodes include:
a primary electrode having at least one end connected to the heating element such that the heating element overlaps at least one end, and formed by printing metal paste; and
a secondary electrode formed by printing metal paste on an upper surface of the primary electrode and having a side surface that is spaced apart from or in contact with the heating element without overlapping the heating element.

6. The film-type radiation heater of claim 5, wherein the secondary electrode is formed on top of the primary electrode.

7. The film-type radiation heater of claim 6, wherein a width of the primary electrode is defined by Equation 2 below.
Primary electrode width=Secondary electrode width+(Distance between secondary electrode and heating element×2)+(Overlap distance between heating element and primary electrode×2) [Equation 2]

8. The film-type radiation heater of claim 7, wherein a width of the secondary electrode is at least 45% of the width of the primary electrode, a distance between the secondary electrode and the heating element is at least 0.1 mm, and an overlap distance between the heating element and the primary electrode is at least 0.5 mm.

9. The film-type radiation heater of claim 1, wherein a total height of the electrode, including a height of the primary electrode and a height of the secondary electrode, is 25 μm or less.

10. The film-type radiation heater of claim 1, wherein the heating element is formed by printing metal paste.

11. The film-type radiation heater of claim 10, wherein the metal paste includes a base resin, metal powder, and a solvent.

12. The film-type radiation heater of claim 11, wherein the base resin includes one or more selected from the group consisting of epoxy resin, polyester resin, and urethane resin.

13. The film-type radiation heater of claim 11, wherein the metal powder includes a powder made of one or more metal materials selected from the group consisting of silver (Ag), copper (Cu), aluminum (Al), stainless steel (SUS), nickel (Ni), and alloys thereof.

14. The film-type radiation heater of claim 11, wherein the solvent includes one or more selected from the group consisting of carbitol acetate, ethyl carbitol, butyl carbitol acetate, and butyl carbitol.

15. The film-type radiation heater of claim 11, wherein, based on a total weight of the metal paste, the content of the base resin is 1 to 10 wt %, the content of the metal powder is 75 to 90 wt %, and the content of the solvent is 8.9 to 13 wt %.

16. The film-type radiation heater of claim 1, wherein the heating element is formed by printing heating paste.

17. The film-type radiation heater of claim 16, wherein the heating paste includes a base resin and conductive particles.
